(19) United States
(12) Patent Application Publication
(10) Pub. No.: US 2022/0055598 A1
(43) Pub. Date: Feb. 24, 2022

(54) LOCK FOR TRAILER EMERGENCY AIR BRAKE SUPPLY LINE COUPLER

(71) Applicant: BABACO ALARM SYSTEMS, INC., Moonachie, NJ (US)

(72) Inventors: GREG HABER, Moonachie, NJ (US); ROBERT HALEY, Bonita Springs, FL (US)

(21) Appl. No.: 16/998,363

(22) Filed: Aug. 20, 2020

(51) Int. Cl. B60T 17/18; B60T 13/38; F16M 13/02; E05B 67/38; F16L 35/00

(52) U.S. Cl. CPC B60T 17/18; B60T 13/38; F16L 35/00; E05B 67/383; F16M 13/02

(57) ABSTRACT

The trailer emergency air brake supply line coupler is movable between a control position, where air pressure in the supply line causes the trailer emergency air brakes to release so the trailer can be moved, and a park position where the trailer emergency air brake system is vented to automatically engage the trailer emergency air brakes. The lock includes a metal frame attached to the trailer proximate the trailer coupler. First and second spaced side walls extend from the rear wall of the frame on opposite sides of the trailer coupler. A retractable pin extends between the side walls and intersects the path of movement of the supply line coupler preventing movement of the supply line coupler between its control position and its park position. A lock cylinder, padlock or other mechanism retains the pin on the frame.

### 1. FIELD OF THE INVENTION

The present invention relates to air brake systems for trailers and more particularly to a lock for the supply line coupler of a trailer emergency air brake system.

### 2. DESCRIPTION OF PRIOR ART INCLUDING INFORMATION DISCLOSED UNDER 37 CFR 1.97 AND 1.98

On the back of a tractor, on the driver side, there are three lines which connect with a trailer. The lines are color coded red, green, and blue. The red line is the air supply line for the trailer's emergency air brake system. The blue line is the air supply line for the trailer's service air brake system. The red and blue lines are connected to the corresponding couplers in the trailer. The green line is the electrical connection between the tractor and trailer. The end of the green line is plugged into a socket on the trailer. These lines are all connected before moving the trailer.

The red air supply line connects the tractor air supply to the trailer. The red air supply line provides air pressure to release the trailer emergency air brake. If the red air supply line breaks, leaks or is disconnected, the trailer emergency air brakes will be automatically engaged, and the trailer cannot be moved. The blue air brake supply line is connected to the trailer service brake system. The driver of the tractor controls the air pressure to engage or release the trailer service air brakes through the blue air brake supply line. The green line is an electrical cable. It supplies electric power for lights, signals and ABS brakes of the trailer.

The emergency air brake supply line has a coupler at the end. The line coupler is connected to a coupler fixed on the trailer to control the trailer emergency air brakes. The line coupler is removably attached to the trailer coupler in a manner which allows the line coupler to rotate relative to the trailer coupler between two different positions.

In one position, the driver can control the operation of the trailer emergency air brakes by regulating the air pressure in the emergency air brake supply line. In the control position, air pressure from the tractor supplied through the emergency air brake supply line coupler causes the trailer emergency air brakes to release, so the trailer can be moved. In the absence of air pressure, the emergency air brakes are automatically engaged, preventing movement of the trailer.

In a second (park) position of the emergency air brake supply line coupler, the trailer emergency air brake supply line can be detached from the trailer emergency air brake supply line coupler. Detaching the trailer emergency air brake supply line from the trailer emergency air brake supply line coupler will vent the trailer emergency air brake system, causing the trailer air brakes to engage. In the park position of the trailer emergency air brake supply line coupler, the trailer emergency air brake system cannot be pressurized, preventing the trailer from being moved. As long as the trailer emergency air brake supply line coupler is in the park position, the driver can disconnect the air supply lines and the electrical cable from the trailer, and the trailer emergency air brakes will remain engaged.

The end of trailer emergency air brake supply coupler is internally threaded. The end of the trailer emergency air brake supply line is externally threaded. Thus, the trailer emergency air brake supply line can be disconnected from the trailer emergency air brake supply line coupler to allow the tractor to be disconnected from the trailer. Disconnecting the emergency air brake supply line coupling from the trailer coupling vents the trailer emergency air brake system, whether the trailer emergency air brake supply line coupler is in the control position or the park position.

Trailers are frequently left loaded with the line coupler in the park position without a tractor and thus without the emergency air brake supply line coupler connected. In that condition, the trailer is venerable to being stolen, even though the trailer emergency air brakes are engaged because the trailer emergency air brake system is vented. However, when the supply line coupler from any tractor is attached to the trailer and the line coupler is moved to the control position, the emergency air brake system of the trailer can be pressurized to release the trailer air brakes. Thus, unauthored individuals can steal the trailer.

In order to avoid unauthorized pressurization of the trailer air brake system to release the emergency the air brakes, a plastic device has been attached to the trailer to prevent the line coupler from being moved to its control position and the system be pressurized. However, these devices are ineffective because they are easily removed, and the trailer stolen.

Further, many trailer thefts occur when a tractor and trailer are stopped in traffic. The thief climbs between the tractor and trailer, moves the line coupler to the park position and disconnects the emergency air brake supply line from the trailer. Often, in this situation, the driver out of fear drives away in the tractor without the trailer to protect themselves and leaves the trailer to be stolen. The thief then moves the line coupler to the control position, pressurizes the trailer emergency air brake system and takes the trailer.

Accordingly, there is a need for a device which will reliably prevent the trailer emergency air brake system from being pressurized to release the trailer emergency air brakes without authorization.

More specifically, there is a need for a device which will prevent a trailer emergency air brake supply coupler from being moved to a position where the trailer emergency air brake system can be pressurized to release the trailer emergency air brake.

### BRIEF SUMMARY OF THE INVENTION

The present invention is a lock for the coupler of the supply line of a trailer emergency air brake system. The lock consists of a strong metal frame designed to be attached to the front of a trailer proximate to and surrounding the trailer coupler. A retractable pin intersects the path of movement of the line coupler. When in place on the frame, the pin does not allow the supply line coupler to be moved between the control position, where the supply line provides compressed air as needed to control the trailer emergency air brakes, and a park position, where the trailer emergency air brake system is vented and the trailer emergency air brakes are engaged.

In the control position, the lock prevents theft of the trailer in stopped traffic because as soon as the supply line is removed by a would-be thief, the trailer emergency air brake system is vented, automatically engaging the trailer emergency air brakes preventing movement of the trailer.

When parking the trailer, before the tractor is disconnected from the trailer, the driver removes the pin from the lock frame and moves the trailer emergency air brake supply line coupler to the park position, venting the trailer emergency air brake system, and causing the trailer air brakes to engage. The pin is then replaced on the frame, preventing the trailer emergency air brake supply line coupler from being moved from the park position to the control position. In the park position, the trailer emergency air brake system cannot be pressurized to release the trailer emergency air brakes. The supply line can then be removed from the line coupler and the trailer can be safely left because the air brakes are engaged, and the trailer cannot be moved.

In its preferred embodiment, the present invention is a lock for the emergency air brake supply line coupler of a trailer emergency air brake system including a trailer coupler fixed to the trailer and configured to connect the emergency air brake supply line to the trailer emergency air brakes. The supply line coupler is movable between a control position, where air pressure in the supply line causes the trailer emergency air brakes to release so the trailer can be moved, and a park position where the trailer emergency air brake system is vented to automatically engage the trailer emergency air brakes. The lock includes a metal frame having a rear wall attached to the trailer proximate the trailer coupler. First and second spaced side walls extend from the rear wall on opposite sides of the trailer coupler. A retractable pin extends between the side walls and intersects the path of movement of the supply line coupler preventing movement of the supply line coupler between its control position and its park position.

A lock cylinder, padlock or other locking mechanism is employed to engage the end of pin to prevent the pin from being retracted from the frame.

The rear wall includes an opening through which the trailer coupler extends. The rear wall is formed of first and second spaced members at least partially defining the rear wall opening.

The pin has an enlarged end which is situated proximate one side wall surface. The enlarged head presents the pin from being pulled through an opening in the side wall.

### BRIEF DESCRIPTION OF THE SEVERAL VIEWS OF DRAWINGS

To these and to such other objects that may hereinafter appear, the present invention relates to a lock for a trailer emergency air brake supply line as described in detail in the following specification and recited in the annexed claims, taken together with the accompanying drawings in which

FIG. 1 is a partial view of the front of a trailer showing the pneumatic and electrical connections with the lock of the present invention installed on the trailer emergency air brake supply line coupler.

FIG. 2 shows the trailer emergency air brake line coupler, the trailer service air brake line coupler and how an air brake supply line coupler connects to a trailer air brake line coupler.

FIG. 3 is an isometric view of the lock of the present invention showing trailer emergency air supple coupler in the control position and the pin received in and secured to the frame;

FIG. 4 is an isometric view of the lock of the present invention showing trailer emergency air brake supply line coupler in the park position, the pin in the retracted position before it is secured to the frame and the pin received in and secured to the frame.

FIG. 5 is a perspective view if the lock frame with the pin in place showing the front, bottom and left side;

FIG. 6 is a perspective view if the lock frame with the pin in place showing the rear, top and left side;

FIG. 7 is a perspective view if the lock frame with the pin in place showing the rear, top and right side;

FIG. 8 is a perspective view if the lock frame with the pin in place showing the front, bottom and right side; and

FIG. 9 is a perspective view of a second preferred embodiment of the frame and pin wherein a padlock is used to secure a pin is modified to receive the padlock lock shackle.

### DETAILED DESCRIPTION OF THE INVENTION

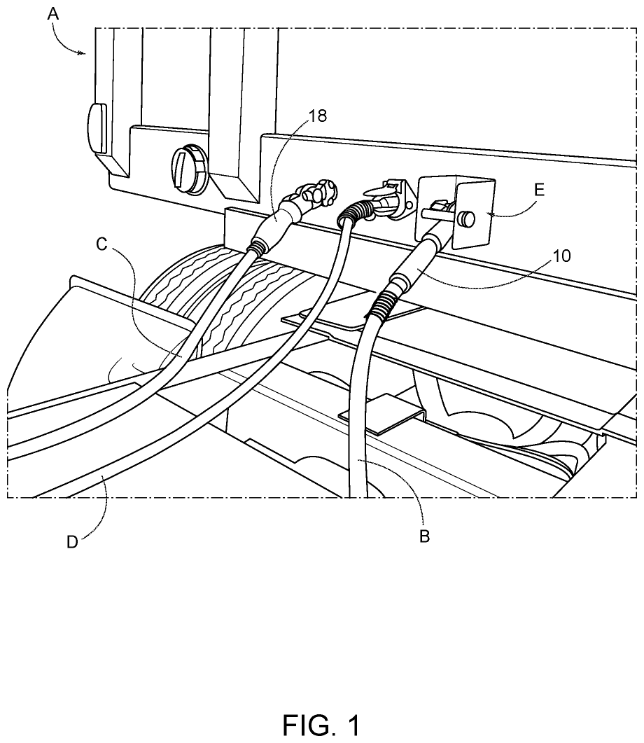

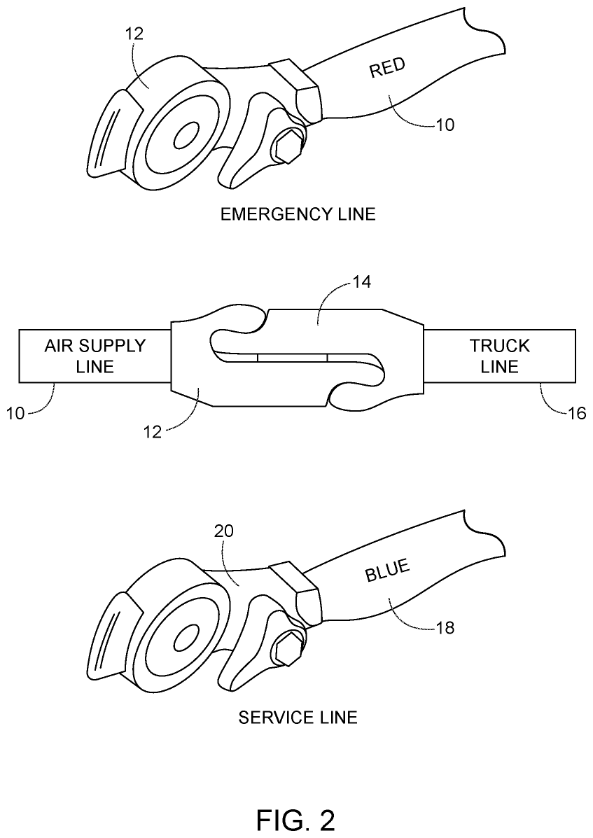

FIG. 1 shows the front of a trailer, generally designated A, with connections to the tractor (not shown). The connections include an emergency air brake supply line, generally designated B, a service air brake system supply line, generally designated C, and an electrical cable, generally designated D.

The emergency air brake supply line B provides air pressure to control the emergency air brakes for trailer A. When high air pressure is present in supply line B, the trailer emergency air brakes are released, and the trailer can be moved. In the absence of air pressure in supply line B (the line is vented), the trailer emergency air brakes automatically engage, and the trailer cannot be moved.

The service air brake supply line C provides air pressure to control the service air brakes of trailer A. When high air pressure is present in supply line C, the trailer service air brakes are released, and the trailer can be moved. In the absence of air pressure in the supply line C (the line is vented), the trailer service air brakes automatically engage, and the trailer cannot be moved.

The electric cable D supplies electric power to operate the lights, signals and ABS brakes of the trailer.

The emergency air brake supply line B is connected to the trailer emergency air brake system by mating couplers. Each coupler has a metal connecting part and a handle part. The emergency air brake supply line coupler has a handle part 10 which is connected to supply line B and a metal connecting part 12 configured to engage the metal engaging part 14 of the emergency air brake system coupler 16 fixed to trailer A.

The service air brake supply line C is connected to the trailer service air brake system by mating couplers. Each coupler has a metal connecting part and a handle part. The service air brake supply line coupler has a handle part 18 which is connected to supply line C and a metal connecting part 20 configured to engage the metal engaging part of the service air brake system coupler fixed to trailer A.

The connections are color coded so they can be easily distinguished. The emergency air brake supply line coupler handle part 10 is red. The service air brake supply line coupler handle part 18 is blue. The electrical cable is green.

The end of each supply line is externally threaded. Each coupler has an in the internally threaded handle part end configured to receive the supply line end. This allows the supply lines to be disconnected from their respective supply line couplers.

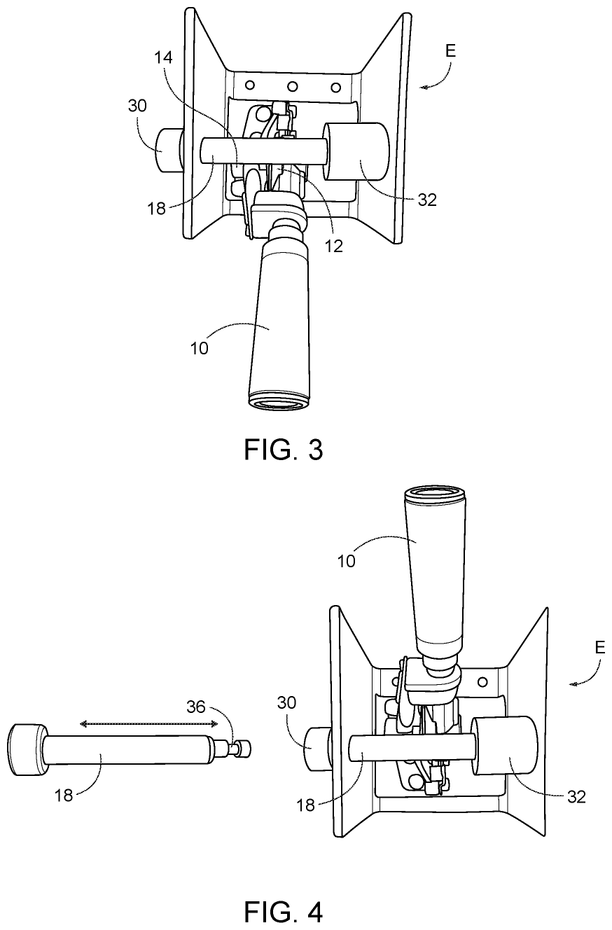

Each supply line coupler can be moved relative to its respective trailer air brake system coupler between control and park positions. FIG. 3 shows the emergency supply line coupler handle part 10 in the control position, which is, for example, 45 degrees below horizontal. In the control position, the emergency air brakes of the trailer can be engaged or released by the driver as needed by regulating the air pressure in the emergency air brake supply line.

FIG. 4 shows the emergency supply line coupler handle part 10 in the park position, which is, for example, 45 degrees above horizontal. In the park position, the emergency air brake system of the trailer is vented, and the emergency air brakes of the trailer are engaged such that the trailer cannot be moved. In the park position, emergency air brake supply line coupler metal connecting part 12 can be disconnected from the metal connecting part 14 of the trailer emergency air brakes system coupler.

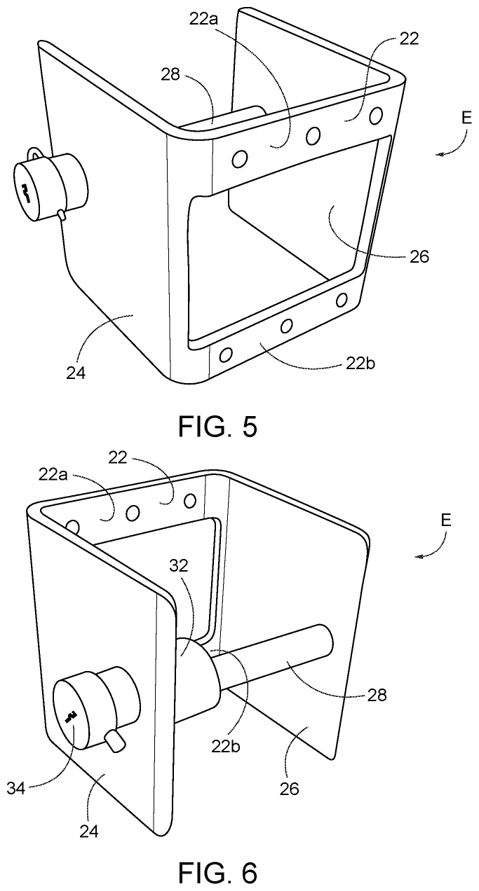

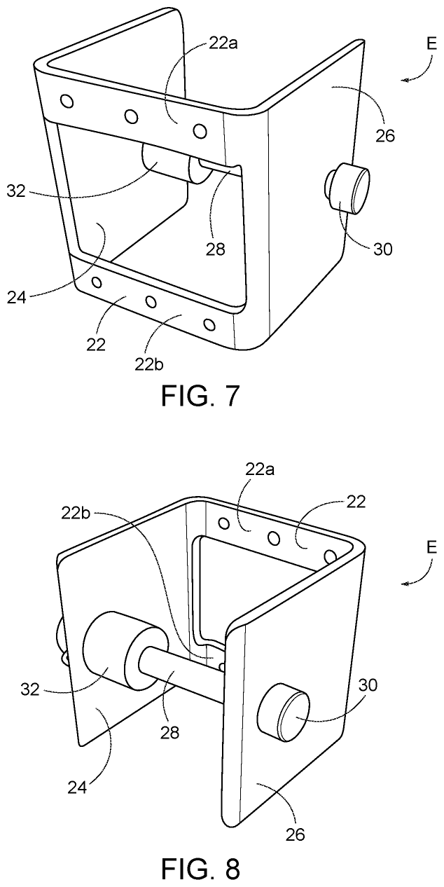

Referring now to FIGS. 5-8, the first preferred embodiment of the present invention includes a strong metal frame, generally designated E. Frame E includes a rear wall 22, a left side wall 24 and a right side wall 26. Side walls 24 and 26 extend from opposite edges of rear wall 22. Rear surface 22 includes spaced members 22a and 22b. Frame E is designed to be fixed to the surface of a trailer by fasteners which extend through the openings in the members. Frame E is mounted on the trailer surface surrounding the emergency air brake supply line coupler handle part 1o, as seen in FIG. 1.

Extending between side walls 24 and 26 is a strong metal pin 28 which, when received on the frame, intersects the path of movement of the emergency air brake supply line coupler handle part 10, such that the emergency air brake supply line coupler handle part cannot be moved between the control position and the park position.

Pin 28 has an enlarged head 30 on one end which limits how far the pin can be moved through an opening in side wall 26. The other end of pin 18 is received in a lock cylinder 32 which is fixed to side wall 24. The external portion of lock cylinder 32 has an entrance opening 34 for a key which causes the lock cylinder to engage or release the pin end.

Referring again to FIGS. 3 and 4, those figures show frame E as it would appear mounted on a trailer proximate to and surrounding the emergency air brake supply line coupler with pin 18 situated on the frame. In FIG. 3, the emergency air brake supply line coupler handle part is in the control position beneath pin 18 and cannot be moved from the control position to the park position unless pin 18 is removed, as indicated in FIG. 4.

With the pin removed, the emergency air brake supply line coupler can be moved to the park position. With the coupler in the park position, the pin can be inserted back into the frame. The pin then prevents the coupler from being moved to the control position. In the park position, the trailer emergency air brake system is vented and cannot be pressurized to release the trailer emergency air brakes. In the park position, the emergency air brake supply line coupler can be disconnected from the trailer.

Pin 18 has an end 36 of reduced diameter with a circumferential recess. Pin end 36 is configured to be received within and engaged by lock cylinder 32. The lock cylinder prevents the removal of the pin from the frame without a key. Thus, movement of the emergency air brake supply line coupler by unauthorized individuals is avoided.

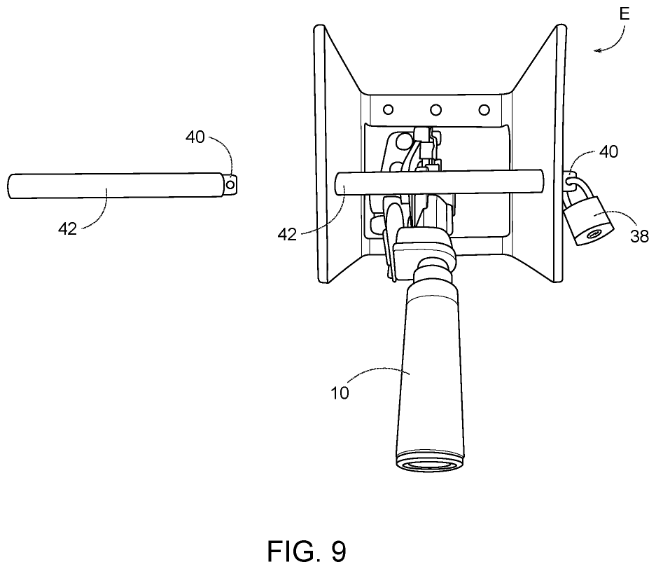

FIG. 9 shows a second preferred embodiment of the present invention. In this embodiment the lock cylinder is replaced by a padlock 38 with a shackle 40. In this embodiment, a pin 42 replaced pin 18 and has a loop end configured to be receive the shackle of the padlock.

It will now be understood that, in the control position, the lock prevents theft of the trailer in stopped traffic because as soon as the supply line is removed by a would-be thief, the trailer emergency air brake system is vented, automatically engaging the trailer emergency air brakes preventing movement of the trailer.

When parking the trailer, before the tractor is disconnected from the trailer, the driver unlocks and removes pin 18 from frame E and moves the trailer emergency air brake supply line coupler to the park position, venting the trailer emergency air brake system, and causing the trailer air brakes to engage. The pin is then replaced and locked on the frame, preventing the trailer emergency air brake supply line coupler from being moved from the park position to the control position. In the park position, the trailer emergency air brake system cannot be pressurized to release the trailer emergency air brakes. The supply line can then be removed from the line coupler and the trailer can be safely left because the air brakes are engaged, and the trailer cannot be moved.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A lock for the emergency air brake supply line coupler of a trailer emergency air brake system including a trailer coupler fixed to the trailer and configured to connect the air supply line to the trailer emergency air brakes, wherein the supply line coupler is movable between a control position, where air pressure in the supply line causes the trailer emergency air brakes to release so the trailer can be moved, and a park position wherein the trailer emergency air brake system is vented to automatically lock the trailer emergency air brakes, the lock comprising a metal frame having a rear wall attached to the trailer proximate the trailer coupler, first and second spaced side walls extending from said rear wall on opposite sides of the trailer coupler, and a retractable pin extending between said side walls and intersecting the path of movement of the line coupler preventing movement of the line coupler between its control position and its park position.

2. The lock of claim 1 further comprising a lock cylinder, padlock or other mechanism engaging said pin to prevent said pin from being retracted from said frame.

3. The lock of claim 1 wherein said rear wall comprises an opening through which the coupler extends.

4. The lock of claim 3 wherein said rear wall comprises first and second spaced members at least partially defining said rear wall opening.

5. The lock of claim 1 wherein one of said side walls has a surface with an opening and wherein said pin comprises an end larger than said side wall opening.

6. The lock of claim 1 wherein said pin has an end comprising a recess.

7. A lock for the air supply line coupler of a trailer air brake system including a trailer coupler fixed to the trailer and configured to connect the air supply line to the trailer air brakes, wherein the supply line coupler is movable between a control position, where air pressure in the supply line causes the trailer air brakes to release so the trailer can be moved, and a park position wherein the trailer air brake system is vented to automatically lock the trailer air brakes, the lock comprising a metal frame having a rear wall attached to the trailer proximate the trailer coupler, first and second spaced side walls extending from said rear wall on opposite sides of the trailer coupler, and a retractable pin extending between said side walls and intersecting the path of movement of the line coupler preventing movement of the line coupler between its control position and its park position.

8. The lock of claim 1 further comprising a lock cylinder, padlock or other mechanism engaging said pin to prevent said pin from being retracted from said frame.

9. A trailer comprising a trailer emergency air brake system including a trailer coupler fixed to the trailer, an emergency air brake, an emergency air brake supply line, an emergency air brake supply line coupler, said line coupler configured to connect said emergency air brake supply line to said trailer emergency air brake, wherein said emergency air brake supply line coupler is movable between a control position, where air pressure in said emergency air brake supply line causes said trailer emergency air brakes to release so the trailer can be moved, and a park position wherein said trailer emergency air brake system is vented to automatically lock said trailer emergency air brakes, a lock comprising a metal frame having a rear wall attached to the trailer proximate the trailer coupler, first and second spaced side walls extending from said rear wall on opposite sides of said trailer coupler, and a retractable pin extending between said side walls and intersecting the path of movement of said line coupler preventing movement of said emergency air brake line coupler between its control position and its park position.

10. The lock of claim 9 further comprising a lock cylinder, padlock or other mechanism engaging said pin to prevent said pin from being retracted from said frame.
